(19) United States
(12) Patent Application Publication
(10) Pub. No.: US 2009/0014184 A1
(43) Pub. Date: Jan. 15, 2009

(54) HIGH CAPACITY WELLHEAD CONNECTOR HAVING A SINGLE ANNULAR PISTON

(76) Inventors: Robert K. Voss, Houston, TX (US); Perry J. Stokes, Houston, TX (US); David W. Hughes, Hilltop Lakes, TX (US); Joseph W. Pallini, JR., Tomball, TX (US); Robert N. Rogers, Tomball, TX (US)

Correspondence Address: BRACEWELL & GIULIANI LLP, P.O. BOX 61389, HOUSTON, TX, 77208-1389, US

(21) Appl. No.: 11/776,171

(22) Filed: Jul. 11, 2007

(51) Int. Cl. E21B 7/12; E21B 43/36; F16L 37/06

(52) U.S. Cl. 166/345; 285/306

(57) ABSTRACT

A wellhead connector for connecting a riser or production tree to a wellhead of a subsea well utilizes a singular annular piston to lock the connector onto the wellhead. The wellhead connector includes a housing that contains dogs for engagement with the exterior of the wellhead housing. A cam ring is also included, which has an inner side for engaging the dogs and moving them inward into a locked position with the wellhead housing. Connecting rods connect the piston to the cam rings. As the piston moves downward, the cam ring also moves downward, forcing the dogs inward into a locked position. As the piston moves upward, the cam ring also moves upward, thereby unlocking the connector. A secondary annular piston is also provided to guarantee unlocking.

### BACKGROUND

1. Field of the Invention

This invention relates in general to subsea wells, and in particular to a connector for connecting a riser to a subsea wellhead housing.

2. Description of the Prior Art

In a subsea well of the type concerned herein, a tubular wellhead is located on the sea floor. During drilling operations, a riser extends from a vessel at the surface down to the wellhead. A wellhead connector connects the lower end of the riser to the wellhead. After the riser is disconnected, a similar wellhead connector may be used to connect a subsea production tree to the wellhead. The wellhead connector has a housing which slides over the wellhead. In one type, a plurality of dogs are carried by the wellhead connector. The dogs include grooves on their interior sides. A cam ring moves the dogs inwardly into engaging contact with grooves formed on the exterior of the wellhead.

A plurality of pistons are spaced apart from each other circumferentially around the wellhead housing to move the cam ring axially between a locked and unlocked position. Because of the large number of pistons, the connectors are large, heavy, and expensive to manufacture. Therefore, what is needed is a wellhead connector that is lighter, more efficient, and less expensive to manufacture.

### SUMMARY OF THE INVENTION

The wellhead connector of the present invention utilizes a singular annular piston to lock the connector onto the wellhead. The connector includes a housing that contains a plurality of dogs having a set of grooves formed on their inner sides for engagement with a set of grooves on the exterior of the wellhead housing. A cam ring is also included, which has an inner side for engaging the dogs and moving them inward into a locked position with the wellhead housing. A plurality of connecting rods connect the annular piston to the annular cam ring. As the piston moves downward, the cam ring also moves downward, forcing the dogs inward into the locked position. As the piston moves upward, the cam ring also moves upward, thereby unlocking the connector. A secondary annular piston is also included to guarantee unlocking.

### BRIEF DESCRIPTION OF THE DRAWINGS

FIG. 1 is a partial sectional view illustrating a wellhead connector according to an embodiment of the present invention, with the left side shown unlocked and the right side shown locked.

### DETAILED DESCRIPTION OF THE INVENTION

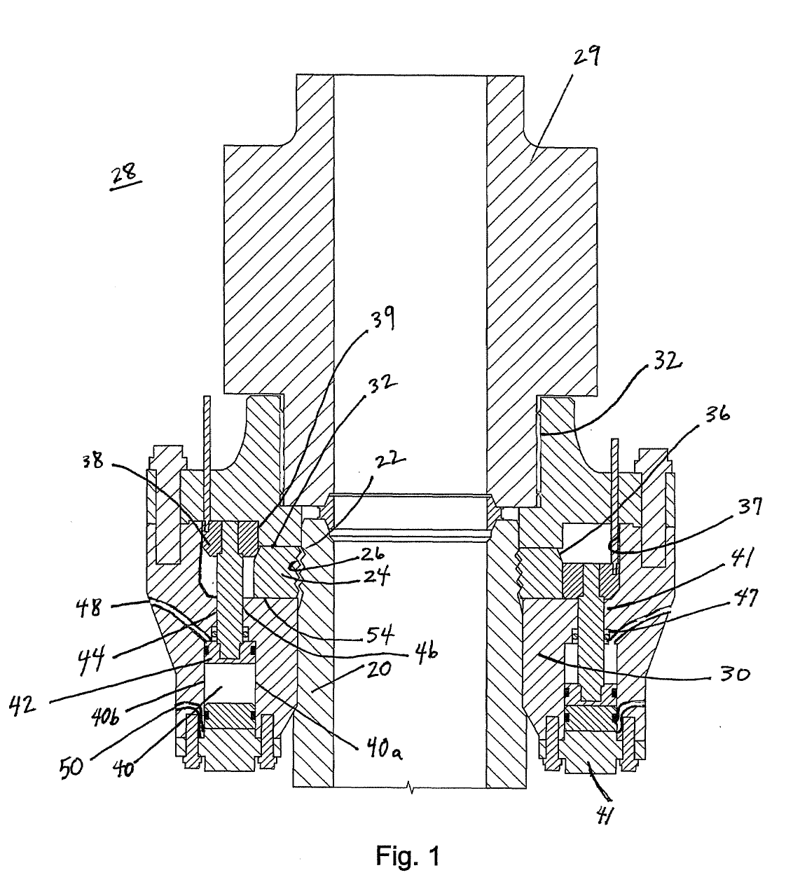

Referring to sole figure, which is FIG. 1, an exemplary embodiment is disclosed that illustrates a wellhead 20, which is a tubular member located vertically on the sea floor. A plurality of circumferential grooves 22 are formed on the exterior of wellhead 20 to provide a locking profile with a plurality of circumferential grooves 26 formed on the inside surfaces of dogs 24. Dogs 24 comprise part of a wellhead connector 28, which may be connected to a subsea production tree 29 by threads 31. Alternately, wellhead connector 28 could be secured to the lower end of a string of riser (not shown) which extends from a vessel at the surface.

The wellhead connector 28 includes a tubular housing 30. Housing 30 has an inner diameter that is slightly greater than the outer diameter of the wellhead 20. The housing 30 will slide over the wellhead 20 as the wellhead connector 28 is lowered into place. Dogs 24 are carried in apertures 32 spaced apart from each other around an inner circumference of wellhead connector 28. The dogs 24 will move between the retracted (i.e., unlocked) position shown on the left side in FIG. 1 to a locked position shown on the right side in FIG. 1.

Each dog 24 has an outer side 34 that is inclined. In this embodiment, the outer side 34 is a straight conical surface with a wider base at the bottom than that of the upper end. It inclines radially outward in a downward direction. A beveled edge 36 is located at the upper end of the outer side 34 of each dog 24. The inclination of each outer side 34 may be about four degrees relative to vertical.

A cam ring 38 is reciprocally carried by the housing 30 within an annular cam ring cavity 37. Aperture 32 is located between the cam ring cavity 37 and the inner wall of housing 30. The cam ring 38 is a solid annular member that moves vertically within annular cavity 37 in housing 30. Cam ring 38 has an inner side 39 that is a toriodal bearing surface for optimized efficiency and load distribution, and which mates with the outer side 34 of dog 24.

A single, annular hydraulic chamber 40 is located in the wellhead connector housing 30 below cam ring cavity 37 and separated by a partition 41. Hydraulic chamber 40 extends around the circumference of wellhead 20 and has an axis coaxial with the axis of wellhead 20. Hydraulic chamber 40 has an inner cylindrical wall 40a and an outer cylindrical wall 40b. Inner and outer walls 40a and 40b are concentric relative to each other. A cap ring 41 is bolted to the bottom of hydraulic chamber 40.

The hydraulic chamber 40 contains an annular primary piston 42 that moves vertically within hydraulic chamber 40. Primary piston 42 has an inner diameter with a seal that slidingly engages hydraulic chamber inner wall 40a. Primary piston 42 has an outer diameter with a seal that slidingly engages hydraulic chamber outer wall 40b.

Primary piston 42 is connected to a plurality of connecting rods 44 (only two shown). Each connecting rod 44 extends through a passage 46 extending through partition 41 of the housing 30 and further connects up to the cam ring 38. A seal 47 in each passage 46 seals around one of the connecting rods 44 to seal the pressure in hydraulic chamber 40 from cam cavity 37. Each connecting rod 44 is cylindrical and has an outer diameter less than the distance between the inner and outer walls 40a, 40b of hydraulic chamber 40. Preferably, the ends of connecting rods 44 are threaded for securing into threaded holes in cam ring 38 and primary piston 42. Connecting rods 44 cause cam ring 38 to move up and down relative to dogs 24 in unison with primary piston 42, as can be seen by comparing the left and right sides of FIG. 1. In an exemplary embodiment, primary piston 42 is connected to cam ring 38 via twelve connecting rods 44, however, other numbers of connecting rods can be used.

A secondary piston 52 is also provided to assure unlocking in the event primary piston 42 fails. Secondary piston 52 is an annular member carried in annular hydraulic chamber 40 below primary piston 42. Secondary piston 52 has an inner diameter with a seal that slidingly engages hydraulic chamber inner wall 40a. Secondary piston 52 has an outer diameter with a seal that slidingly engages hydraulic chamber outer wall 40b. Secondary piston 52 is not physically connected to primary piston 42 nor to connecting rods 44. When at its lower position, secondary piston 52 rests on top of the upper vertical surface of cap ring 41.

An upper port 48 extends through housing 30 to hydraulic chamber 40 above primary piston 42 when primary piston 42 is in its upper position. Upper port 48 provide hydraulic fluid pressure to the upper side of primary piston 42 to force it downward. A lower port 50 extends through housing 30 below secondary piston 50 when secondary piston 50 is in its lower position, shown on both sides of FIG. 1. Lower port 50 provides hydraulic fluid pressure to the lower side of secondary piston 52 to force secondary piston 52 and primary piston 42 upward to unlock connector 28.

In operation, the wellhead connector 28 will be lowered over the wellhead 20 until reaching the position shown in FIG. 1. Initially, dogs 24 will be in the retracted position, shown on the left side of FIG. 1. The cam ring 38 and primary piston 42 will be in an upper position because of the position of dogs 24. Secondary piston 52 would be in the lower position shown due to its weight. Hydraulic fluid is then supplied to the upper port 48, which forces primary piston 42 to move downward bringing with it cam ring 38. This will initially start the dogs 24 moving inward by the engagement with the inner side 39 of cam ring 38. The connecting rods 44 will continue downward with the primary piston 42 until dogs 24 have fully engaged wellhead housing 20 and a selected hydraulic pressure is reached. At that point, cam ring 38 will be spaced slightly above the top surface 54 of partition 47 of tubular housing 30 as shown in the right side of FIG. 1. When dogs 24 are in the fully locked position, a control mechanism (not shown) will release the hydraulic fluid flow through the upper port 48. Primary piston 42 will be closely spaced to from the top of secondary piston 52.

When it is desired to release the wellhead connector, hydraulic fluid pressure is supplied to the lower port 50. This causes the secondary piston 52 to push upward on primary piston 42. As the primary piston 42 moves upward, cam ring 38 moves upward out of engagement with dogs 24. Because of the angle of the downward facing shoulders of grooves 26, an upward pull on housing 30 after cam ring 38 has released dogs 24 causes dogs 24 to slide out of engagement with grooves 26. If secondary piston 52 leaks, the hydraulic fluid pressure would act directly on primary piston 42 to cause it to move upward to unlock the wellhead connector.

The invention has significant advantages. The single annular piston results in a lighter, more efficient, and less expensive wellhead connector than the prior art types. The use of a separate primary and secondary pistons enables the connector to be released even if the secondary piston leaks.

While this invention has been shown in only one of its forms, it should be apparent to those skilled in the art that it is not so limited but is susceptible to various changes without departing from the spirit and scope of the invention.

We claim:

1. A wellhead connector for connecting an upper tubular member to a lower tubular member, the connector comprising:
a housing adapted to be secured to the upper tubular member for sliding over the lower tubular member, the housing having an axis, an annular cam cavity, and an annular hydraulic chamber axially separated from the cam cavity by an annular partition;
a plurality of dogs carried in the cam cavity, each of the dogs being located within an inner window of the housing for movement from an unlocked position inward to a locked position for engagement with a profile on the exterior of the lower tubular member;
a cam ring carried in the cam cavity for axial movement, the cam ring having an inner side which engages an outer side of each of the dogs for moving the dogs inward into the locked position;
an annular primary piston carried in the hydraulic chamber for axial movement; and
a plurality of rods connected between the primary piston and the cam ring for moving the cam ring in unison with the primary piston, each of the rods extending sealingly through a hole formed in the annular partition.

2. The wellhead connector of claim 1, wherein the primary piston is located below the cam ring.

3. The wellhead connector of claim 1, wherein each connecting rod is cylindrical and has a smaller diameter than a transverse width of the cam ring and the primary piston.

4. The wellhead connector of claim 3, wherein the connecting rods further comprise threaded ends connected to the cam ring and the primary piston.

5. The wellhead connector of claim 1, further comprising:
an annular secondary piston located on a side of the primary piston in the hydraulic chamber opposite the partition, the primary piston being movable relative to the secondary piston in a direction away from the partition; and
the secondary piston being movable toward the partition for pushing the primary piston toward the partition to disengage the cam ring from the dogs.

6. The wellhead connector of claim 1, further comprising
an upper hydraulic flow passage extending through the housing to the hydraulic chamber at a point above the primary piston while in an upper position to stroke the primary piston in a downward direction; and
a lower hydraulic flow passage extending through the housing to the hydraulic chamber at a point below the secondary piston while in a lower position to stroke the secondary and the primary pistons upward.

7. A subsea wellhead assembly comprising:
an upper tubular member;
a lower tubular member;
a housing secured to the upper tubular member and positioned over the lower tubular member, the housing having an axis, an annular cam cavity, and an annular hydraulic chamber located below the annular cam cavity, the cam cavity and hydraulic chamber being axially separated from each other by an annular partition, and the hydraulic chamber having cylindrical, concentric inner and outer walls extending around the axis of the housing;
a plurality of dogs carried in the cam cavity, each of the dogs being located within an inner window of the housing for movement from an unlocked position inward to a locked position for engagement with a profile on the exterior of the lower tubular member;
a cam ring carried in the cam cavity for axial movement, the cam ring having an inner side which engages an outer side of each of the dogs for moving the dogs inward into the locked position;
an annular primary piston carried in the hydraulic chamber for axial movement, the primary piston having seals on its inner and outer sides for engaging the inner and outer walls of the hydraulic chamber; and
a plurality of rods connected between the primary piston and the cam ring for moving the cam ring in unison with the primary piston, each of the rods extending sealingly through a hole formed in the annular partition.

8. The subsea wellhead assembly of claim 7, wherein the hydraulic chamber has a lower end defined by a removable cap ring.

9. The subsea wellhead assembly of claim 7, wherein each connecting rod is cylindrical and has a smaller diameter than a transverse width of the cam ring and the primary piston.

10. The subsea wellhead assembly of claim 7, wherein the connecting rods further comprise threaded ends connected to the cam ring and the primary piston.

11. The subsea wellhead assembly of claim 7, further comprising an annular secondary piston located below the primary piston, the primary piston being capable of movement to the locked position independent of the secondary piston.

12. The subsea wellhead assembly of claim 11, further comprising:
an upper hydraulic flow passage extending through the housing to the hydraulic chamber at a point above the primary piston while in its upper position to stroke the primary piston in a downward direction; and
a lower hydraulic flow passage extending through the housing to the hydraulic chamber at a point below the secondary piston while the secondary piston is in a lower position to stroke the secondary and primary pistons upward in unison.

13. A subsea wellhead assembly comprising:
an upper tubular member;
a lower tubular member;
a housing secured to the upper tubular member for sliding over the lower tubular member, the housing having an axis, an annular cam cavity, and an annular hydraulic chamber located below the annular cam cavity, the cam cavity and hydraulic chamber being axially separated from each other by an annular partition, and the hydraulic chamber having inner and outer walls extending concentrically around the axis of the housing;
a plurality of dogs carried in the cam cavity, each of the dogs being located within an inner window of the housing for movement from an unlocked position inward to a locked position for engagement with a profile on the exterior of the lower tubular member;
a cam ring carried in the cam cavity for axial movement, the cam ring having an inner side which engages an outer side of each of the dogs for moving the dogs inward into the locked position;
an annular primary piston carried in the hydraulic chamber for axial movement, the primary piston having seals on its inner and outer sides for engaging the inner and outer walls of the hydraulic chamber;
an annular secondary piston located below the primary piston, the primary piston being movable to the locked position independent of the secondary piston;
a plurality of rods connected between the primary piston and the cam ring for moving the cam ring in unison with the primary piston, each connecting rod being cylindrical and having a smaller diameter than a transverse width of the cam ring and primary piston, each of the rods extending sealingly through a hole formed in the annular partition;
an upper hydraulic flow passage extending through the housing to the hydraulic chamber at a point above the primary piston while in its upper position to stroke the primary piston in a downward direction; and
a lower hydraulic flow passage extending through the housing to the hydraulic chamber at a point below the secondary piston while in a lower position to stroke the secondary and primary pistons upward.

14. The subsea wellhead assembly of claim 13, further comprising a cap ring secured to a lower portion of the housing and defining a lower end of the hydraulic chamber.

15. The subsea wellhead assembly of claim 13, wherein the connecting rods further comprise threaded ends connected to the cam ring and primary piston.
